(19) United States
(12) Patent Application Publication
(10) Pub. No.: US 2026/0150075 A1
(43) Pub. Date: May 28, 2026

(54) POSITION DETECTION SERVER AND POSITION CHANGE GRASPING METHOD

(71) Applicant: NTT, Inc., Tokyo (JP)

(72) Inventors: Shinya Tamaki, Musashino-shi, Tokyo (JP); Ryota SHIINA, Musashino-shi, Tokyo (JP); Tomohiro TANIGUCHI, Musashino-shi, Tokyo (JP)

(21) Appl. No.: 19/121,287

(22) PCT Filed: Oct. 20, 2022
(86) PCT No.: PCT/JP2022/039030

§ 371 Date: Apr. 15, 2025

(51) Int. Cl. H04W 64/00; H04W 4/33

(52) U.S. Cl. CPC H04W 64/00; H04W 4/33

(57) ABSTRACT

An object of the present invention is to provide a position detection server and a position fluctuation grasping method capable of easily grasping a positional deviation of a device group configuring an IoT service without manual intervention as much as possible and improving reliability of IoT data. A position detection server 13d according to the present invention is characterized in that it is provided in a data collection system in which a terminal 11 transmits information to a management node 13 at arbitrary timing and the management node 13 stores the information for each terminal 11, and includes a position computation unit 13d3 that compares the information from the past and the latest information stored in the management node 13 for each terminal 11 and defines the terminal 11 having a difference between the information from the past and the latest information as a terminal 11-1 whose position has fluctuated.

### TECHNICAL FIELD

The present disclosure relates to sensing data collection in IoT (Internet of Things) .

### BACKGROUND ART

Network configuration information and equipment information of a terminal and equipment are acquired by a lightweight communication protocol standardized and not requiring high performance. For example, in NPL 1, a method using LLDP (Link Layer Discovery Protocol, for example, see NPL 3) is reported.

In IoT, it is necessary to connect a number of sensor terminals to a network and collect data (sensing data) generated by the sensor terminals. In addition, in data utilization in IoT, importance of not only sensing data itself generated by the sensor terminals but also data related to the sensing data called metadata is reported (NPL 2, etc.), it is expected that a user safely and easily utilizes the sensing data by acquiring and distributing the sensing data and the metadata together. For example, if the LLDP disclosed in NPL 1 is used, metadata (equipment information) such as a manufacturer name and a model number related to the sensing data can be collected with an economical system configuration.

### CITATION LIST

### Non Patent Literature

[NPL 1] Yoshiyuki Mihara, Takefumi Yamazaki, Manabu Okamoto, and Atsushi Sato, “Designing HTIP which Identifies Home Network Topology and Applying HTIP to a Troubleshooting Application”, The Journal of the Institute of Electronics, Information and Communication Engineers consumer device & system, Vol. 2, No. 3, pp. 34-45, Dec. 2012.
[NPL 2] Toshihiko Oda, Hiroshi Imai, Takeshi Naito, and Hajime Takebayashi, “An Approach of Defining, Generating and Utilizing Metadata for Sensing Data Trading Market”, the 32nd annual conference of the Japanese society for artificial intelligence, 2018, June 2012.
[NPL 3] IEEE Std 802.1AB-2016, “IEEE Standard for Local and metropolitan area networks-Station and Media Access Control Connectivity Discovery”
[NPL 4] IEEE Std 802.11TM-2016 P. 708 (Probe Request), P. 712 (Probe Response)

### SUMMARY OF INVENTION

### Technical Problem

While it is expected that a service utilizing an IoT sensor (sensing device) is increasingly spread in future, in managing the service, it is assumed that condition of a sensor (for example, a location, environment, an installation orientation, fixation status, power supply amount, etc.) that is different from intention of a manager occurs without the manager being aware of it. In such condition, correct data cannot be obtained from the sensor, erroneous control may be performed, and appropriate service may not be performed. In order to avoid such condition, it is necessary to periodically confirm the condition of the sensor, but there is a problem that it is difficult for a worker to inspect a large number of sensors. In addition, although it is possible to grasp a position of the sensor by using a BLE beacon, this requires an arrangement of a large number of BLE beacons at precise positions, and there is a problem that it is difficult for the worker to precisely perform this work and confirm a positional deviation of the BLE beacon.

Then, in order to solve the above-described problem, an object of the present invention is to provide a position detection server and a position fluctuation grasping method capable of easily grasping the positional deviation of a device group configuring an IoT service without manual intervention as much as possible and improving reliability of IoT data.

### Solution to Problem

In order to solve the above-described problem, a position detection server according to the present invention determines that a position of a terminal is deviated when information acquired steadily from the terminal fluctuates.

Specifically, the present invention is characterized in that a position detection server is provided in a data collection system in which the terminal transmits information to a management node at arbitrary timing and the management node stores the information for each terminal, and includes a position computation unit that compares the information from the past and the latest information stored in the management node for each terminal, and defines the terminal having a difference between the information from the past and the latest information as a terminal whose position has fluctuated.

In addition, the present invention is characterized in that it relates to a position fluctuation grasping method for grasping position fluctuations of a plurality of terminals, and includes a step of comparing the information from the past with the latest information for each of the terminals and a step of defining the terminal having a difference between the information from the past and the latest information as a terminal whose position has fluctuated.

For example, when the information is coordinates of the terminal,
the position computation unit moves the terminal whose position has fluctuated to coordinates after the fluctuation on a floor map displaying the terminals, or moves the terminal whose position has fluctuated to coordinates after the fluctuation on a network map displaying the terminals.

The coordinates where the terminals are arranged are grasped, and when the coordinates are changed, it can be judged that the terminal has moved. By moving a mark of the terminal on the floor map or the network map in accordance with the fluctuation of the coordinates of the terminal, the worker can easily recognize the change of the terminal.

In addition, for example, when the information is sensing data acquired by the terminal,
the position computation unit displays the sensing data on a graph in which the sensing data of the terminal whose position has fluctuated is arranged in time series, which distinguishing the sensing data before and after the time point when the position fluctuation occurs.

When the sensing data acquired by the terminal is arranged in time series, the data have continuity if there is no change in the position of the terminal. However, if there is a change in the position of the terminal, the continuity of the data is lost at the time point as a boundary. Thus, the worker can easily recognize the change of the terminal from the continuity of the data arranged in time series.

Note that each invention described above can be combined as much as possible.

### Advantageous Effects of Invention

The present invention can provide a position detection server and a position fluctuation grasping method capable of easily grasping a positional deviation of a device group configuring an IoT service without manual intervention as much as possible and improving reliability of IoT data.

### BRIEF DESCRIPTION OF DRAWINGS

FIG. 1 is a diagram for explaining a data collection system related to the present invention.

FIG. 2 is a diagram for explaining a terminal of the data collection system related to the present invention.

FIG. 3 is a diagram for explaining a management node of the data collection system related to the present invention.

FIG. 4 is a diagram for explaining a frame transmitted from the terminal to the management node.

FIG. 5 is a diagram for explaining the data collection system including a position detection server according to the present invention.

FIG. 6 is a diagram for explaining the position computation server according to the present invention.

FIG. 7 is a diagram for explaining operation of the position detection server according to the present invention.

FIG. 8 is a diagram for explaining operation of the position detection server according to the present invention.

FIG. 9 is a diagram for explaining operation of the position detection server according to the present invention.

### DESCRIPTION OF EMBODIMENTS

Embodiments of the present invention will be described with reference to the accompanying drawings. The embodiments to be described below are examples of the present invention, and the present invention is not limited to the following embodiments. Note that configuration components with the same reference numerals in the present specification and the drawings represent the same configuration components each other.

### Embodiment 1

In the present embodiment, a basic configuration of a data collection system will be described.

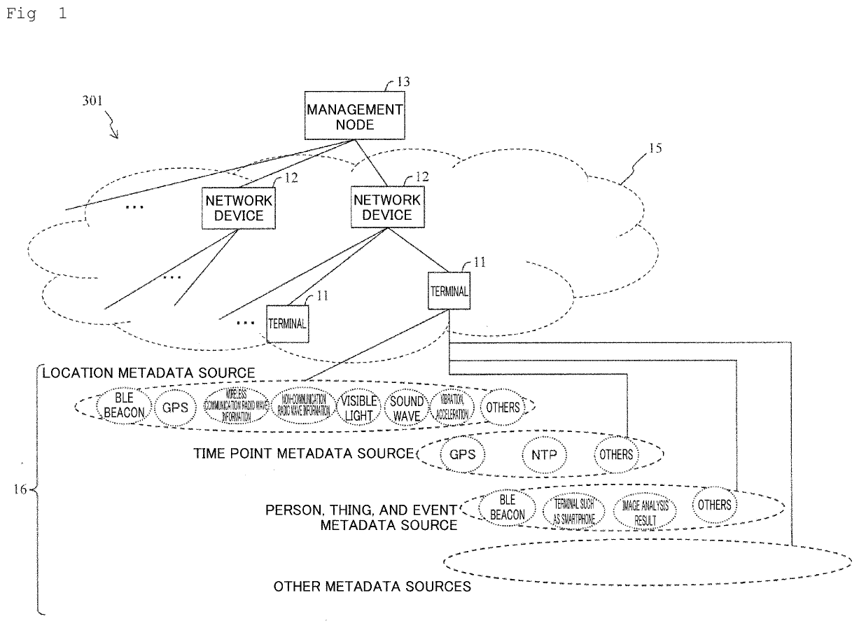

FIG. 1 is a diagram for explaining a data collection system 301 of the present embodiment. The data collection system 301 is a data collection system that utilizes an extended region of a communication protocol (LLDP or HTIP, IEEE 802.11, etc.) standardized for communication from a terminal 11 to a network device 12 to perform and is characterized in that the terminal 11 stores sensing data detected by a sensor device in a region different from a region for storing metadata in a frame defined by the communication protocol and transmits the sensing data to the network device 12, the network device 12 transfers the frame to a management node 13, and the management node 13 stores the sensing data linked to the metadata on the basis of information for identifying the terminal 11 described in the frame.

A data collection network 15 is a network for connecting the sensor terminal 11 existing in a specific range to the management node 13. The data collection network 15 is, for example, a local area network (LAN), a field area network (FAN), an IoT area network, etc. In the same data collection network 15, there are a case where a plurality of sensor terminals 11 of a single type exists and a case where a plurality of sensor terminals of multiple types exists.

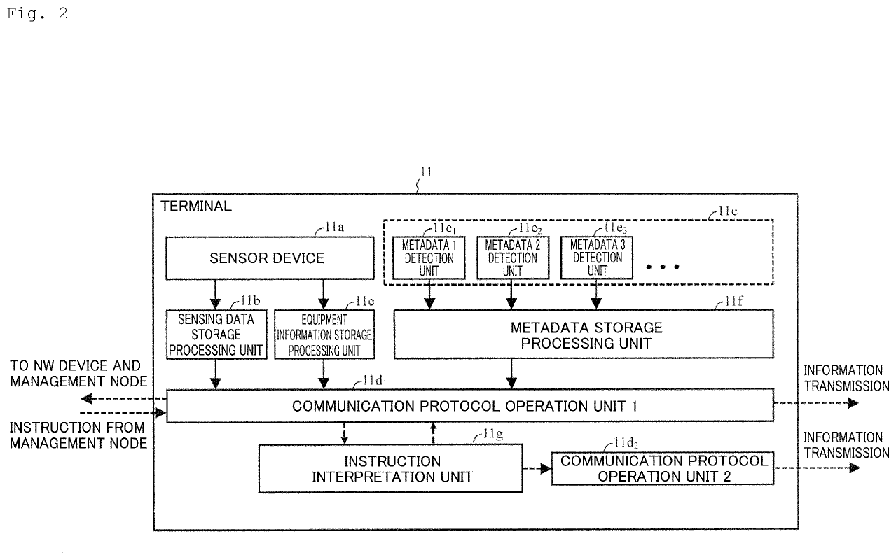

FIG. 2 is a diagram for explaining the terminal 11.

The terminal 11 is, for example, an IoT sensor terminal, performs sensing on an observation target, and generates sensing data. The terminal 11 has a sensor device 11a, a sensing data storage processing unit 11b, an equipment information storage processing unit 11c, a protocol operation unit 11d₁, a metadata detection unit (11e₁, 11e₂, 11e₃, . . . ), and a metadata storage processing unit 11f.

The sensor device 11a performs the sensing related to the observation target and acquires the sensing data (main data). The sensing data includes, for example, temperature, an image, acceleration, sound, light, CO2, or the like.

The equipment information storage processing unit 11c collects equipment information (for example, a maker name, a model name, a model number, or the like of equipment) of the observation target and stores the information in a predetermined position (region that are usable for an independent use such as “extended region”, “option region”, and the like defined by the protocol) of the frame.

The sensing data storage processing unit 11b stores the sensing data from the sensor device 11a at a predetermined position (payload part or the like defined by the protocol) of the frame. In order to conform to the format/restrictions of the independent extended region of the frame, the sensing data storage processing unit 11b may store the sensing data in the frame after being processed such as converting the sensing data into a certain shortened code to store it and dividing the sensing data to store it in a plurality of frames (fragmentation).

The sensing data storage processing unit 11b can arbitrarily set storage timing for storing the sensing data in the frame. For example, the storage timing may be set to each time the sensing data is updated, or the sensing data may be stored not sequentially but at timing at which the sensing data is stored for a fixed period. In addition, when storing the sensing data for the fixed period, the sensing data storage processing unit 11b may store the recording (log) or a result of specific calculation/statistical processing in the frame.

The type and storage timing of the sensing data to be stored in the frame may be fixed or varied. The type and storage timing of the sensing data may be dynamically changed by the determination of the sensor terminal 11 itself and an instruction from a data analysis unit 13 and the data collection unit 12.

Further, a transmission cycle of the frame may be fixed or varied. The transmission cycle of the frame may be dynamically changed by the determination of the sensor terminal 11 itself and the instruction from the data analysis unit 13 or the data collection unit 12.

The metadata detection unit 11e acquires information (metadata) other than the equipment information. The information other than the equipment information is, for example, position information of the detection target, time position information, person, thing, or event information, and other pieces of information. However, the present invention does not limit information other than the equipment information to these. The metadata detection unit 11e has a position information detection unit 11e₁, a time point detection unit 11e₂, a person, thing, event detection unit 11e₃, and other detection units.

The position information detection unit 11e₁ is, for example, a GPS, an acceleration sensor, a gyro sensor, or an RSSI receiver such as a Wi-Fi signal or a BLE beacon signal. Then, location metadata detected by the position information detection unit 11e₁ is information on the position acquired from a GPS signal, a BLE beacon signal, radio wave information of wireless communication, radio wave information (television, radio, wave clock, other noise, or the like) of non-communication, power information, visible light information, sound wave information, vibration information, acceleration information, and other location metadata sources.

The time point detection unit 11e₂ is, for example, an information receiver from the GPS and an NTP (Network Time Protocol). Then, the time point metadata detected by the time detection unit 11e₂ is information on a time point acquired from the GPS signal, information from the NTP, and other time point metadata sources.

A person, thing, and event detection unit 11e₃ is, for example, a receiver that receives a BLE beacon (made to be carried by a person), information from a smart phone carried by a person, and information from an image analysis result. The person, thing, and event metadata detected by the person, thing, event detection unit 11e₃ is information on the person, thing, or event acquired from the BLE beacon carried by the person or from the smart phone carried by the person, information from the image analysis result, and other current affairs metadata sources.

The metadata detected by other detection units include information on network configuration and the like.

Note that the metadata detection unit 11e may detect all of a plurality of detection targets or any one of them.

The metadata storage processing unit 11f stores the data detected by the metadata detection unit 11e as the metadata in the extended region or an option region in the frame set by the communication protocol. For example, the metadata storage processing unit 11f can store the metadata in a control system frame of IEEE 804.11 wireless LAN. Specifically, various types of metadata are stored in a “Vendor Specific” region which is an extended region of a Probe Request frame. Alternatively, various types of metadata are stored in a “Vendor Specific” region which is an extended region of a Probe Response frame.

In order to conform to the format/restrictions of the independent extended region of the frame, the metadata storage processing unit 11f stores the metadata after being processed such as converting the metadata into a certain shortened code to store it or dividing the metadata to store it in a plurality of frames (fragmentation).

The metadata storage processing unit 11f can arbitrarily set storage timing for storing the metadata in the frame. For example, the storage timing may be set to each time the metadata is updated, or the metadata may be stored at timing in which the metadata is stored for the fixed period instead of being stored sequentially. Further, when the meta data is stored for the fixed period, the metadata storage processing unit 11f may store the recording (log) or the result of specific calculation/statistical processing in the frame.

The type and storage timing of the metadata stored in the frame may be fixed or fluctuated. The type and storage timing of the metadata may be dynamically changed by the determination of the terminal 11 itself and the instruction from the management node 13.

The protocol operation unit 11d₁ transmits the frame in which the sensing data and equipment information are stored in a predetermined region and the metadata is stored in the extended region or the option region to the network device 12 by using a lightweight and standardized communication protocol such as LLDP or HTIP. Note that the communication protocol of the frame in which the sensing data is stored and the communication protocol of the frame in which the equipment information is stored may be the same or different. In the latter case, the metadata storage processing unit 11f may store the metadata in the frame (frame in which the sensing data is stored or frame in which the equipment information is stored) of any one communication protocol, or may store the metadata in the frame (frame in which the sensing data is stored and frame in which the equipment information is stored) of both communication protocols.

Further, the terminal 11 also has a function of operating in accordance with an instruction from the management node or the like. Specifically, the terminal 11 has an instruction interpretation unit 11g, and transmits the information to the outside in accordance with the instruction from the management node 13, when the BLE beacon signal and metadata information (information to be transmitted, radio wave intensity, transmission frequency, or the like) to be transmitted by the terminal itself is changed. When information is transmitted by the same protocol as that of the communication with the network device 12, the communication protocol operation unit 11d₁ is operated. When information is transmitted by a protocol different from that of the communication with the network device 12, a communication protocol operation unit 11d₂ is provided in addition to the communication protocol operation unit 11d₁, and the communication protocol operation unit 11d₂ is operated.

Note that a case in which the terminal 11 itself is a beacon signal source for other terminals to grasp the metadata is included. For example, the terminal 11 may be the beacon signal source for identifying the location metadata or a beacon terminal carried by a worker for identifying a person in proximity.

The network device 12 is, for example, a device such as a network switch, a wireless access point, and a wireless repeater. The network device 12 transmits a frame group uploaded from the lower data collection network 15 to the management node 13 as it is.

Here, the network device 12 may have a processing part (metadata detection unit 11e and metadata storage processing unit 11f) of metadata included in the terminal 11. The network device 12 additionally gives unique information such as its own MAC address and metadata such as a connection port to the frame transmitted from the terminal 11 and can transfer the frame to the management node 13, or transmits the frame to the management node 13 to which an own identifier or the like is added, even when not having the sensor device 11a.

When the network device 12 has the processing part of the metadata, logical connection from the management node 13 to the terminal 11 can be grasped, and a more precise logical/physical network management map can be created.

That is, even if the network device 12 is a network switch (switching hub) or a wireless repeater having no function of layer 3 or more, the present technique is performed in layer 2, so that the connection of network equipment including the network device 12 can be managed/grasped.

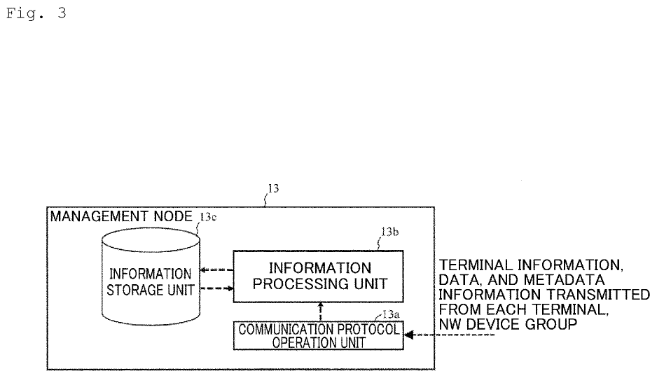

FIG. 3 is a diagram for explaining the management node 13. The management node 13 has a protocol operation unit 13a, an information processing unit 13b, and an information storage unit 13c. The management node 13 takes out information from the frame delivered from the network device 12 to stores it, and provides it for analysis. In particular, it is characterized in that the management node 13 has a function of storing a combination of two or more pieces of collected information in the information storage unit 13c.

The protocol operation unit 13a receives the frame storing the sensing data and the metadata from the terminal 11 and the network device 12. The information processing unit 12b takes out the following sensing data, equipment information and metadata from the received frame and arranges them in the information storage unit 13c on the basis of information (for example, MAC address) for identifying an individual of the terminal 11.
(1) Physical information of the terminal (information such as characteristics of a housing, image information, information of a label attached thereto, a target on which the worker fingers, and a target of a line of sight of the worker)
(2) Identifier (MAC address, UUID, or the like) of the terminal on a logical network
(3) Main data (sensing data such as temperature, image, acceleration, sound, light, and CO2)
(4) Various types of metadata (data such as location, time point, person, thing, and event)

For example, the management node 13 refers to the metadata related to the location and stores the main data acquired in the same location or in a certain region in a form of [location metadata, main data].

### Supplement

The location metadata is supplemented.

There is a case where the data sensed by the terminal 11 becomes direct location metadata such as GPS information. On the other hand, at a point when the data, such as the signal from the BLE beacon, visible light, or sound information, is sensed by the terminal 11 and transmitted as the metadata, the data is not determined to be the location information, and the management node 13 may recognize/grasp the metadata as location metadata.

### End of Supplement

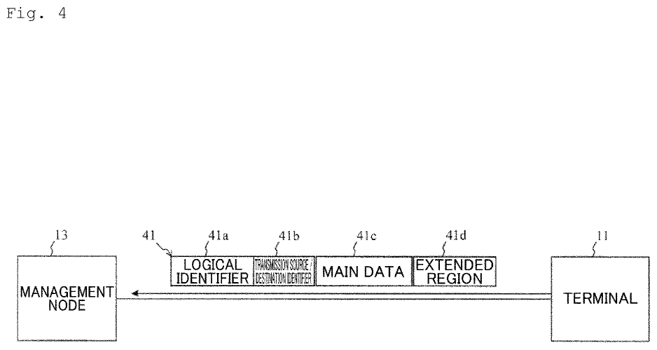

FIG. 4 is a diagram for explaining a frame 41 transmitted from the terminal 11 to the management node 13. In FIG. 4, description of the network device 12 is omitted. The frame 41 is a layer 2 communication frame such as an Ethernet (registered trademark) frame or a Wi-Fi communication frame. The frame 41 is composed of a logical identifier 41a of a communication device such as a MAC address, an identifier 41b of a transmission source and a destination such as an IP address, a region 41c storing sensing data such as temperature and an image, and an extended region 41d storing metadata. Among them, the identifier 41b and the region 41c become a layer 3 communication packet.

The management node 13, for example, combines the MAC address of the logical identifier 41a and the location metadata of the extended region 41d to link them together as [MAC address, location metadata], combines the MAC address of the logical identifier 41a and installation person metadata of the extended region 41d to link them together as [MAC address, installation person metadata], and arrange them in the information storage unit 13c.

In this way, the data collection system 301 can acquire network configuration information, equipment information, sensor data, and metadata of the terminal and equipment by the communication protocol not requiring the high performance.

### Embodiment 2

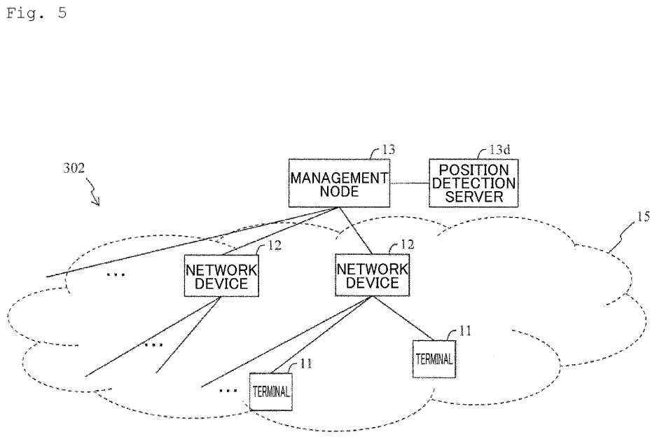

FIG. 5 is a diagram for explaining a data collection system 302 of the present embodiment. The data collection system 302 further includes a position detection server 13d in the data collection system 301 described in FIG. 1. Note that although the position detection server 13d is described separately from the management node 13 in the present embodiment, the management node 13 may incorporate the position detection server 13d.

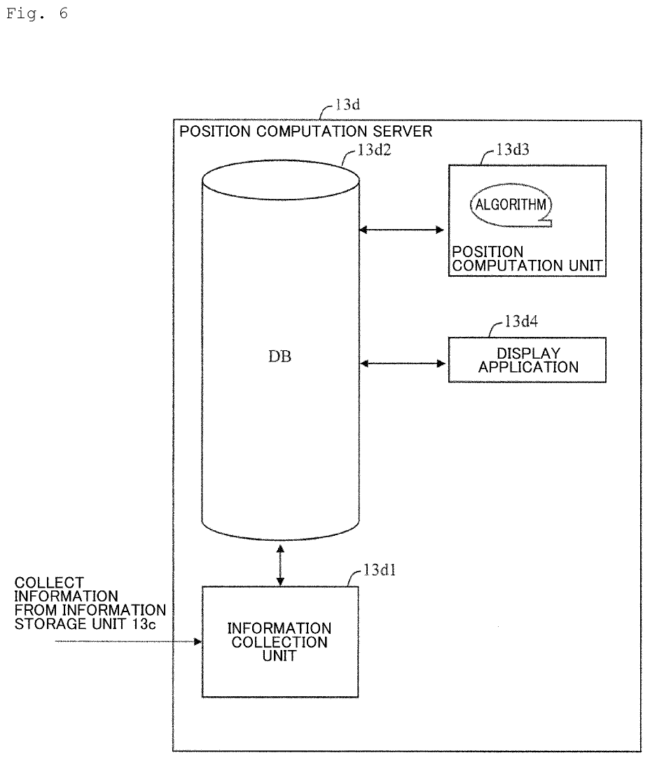

FIG. 6 is a diagram for explaining the position detection server 13d. The position detection server 13d includes an information acquisition unit 13d1, a database 13d2, a position computation unit 13d3, and a display application 13d4.

The information acquisition unit 13d1 accesses the information storage unit 13c of the management node 13 to acquire necessary information. In this embodiment, the case where the necessary information is data related to the terminal 11 and the position linked to it will be described. Specifically, the information acquisition unit 13d1 acquires information of [MAC address, location metadata] from the information storage unit 13c, and stores it in the database 13d2.

The position computation unit 13d3 compares the information from the past and the latest information stored in the database 13d2 for each terminal 11, and defines the terminal 11 having a difference between the information from the past and the latest information as a terminal whose position has fluctuated. In the present embodiment, the information is coordinates of the terminal 11.

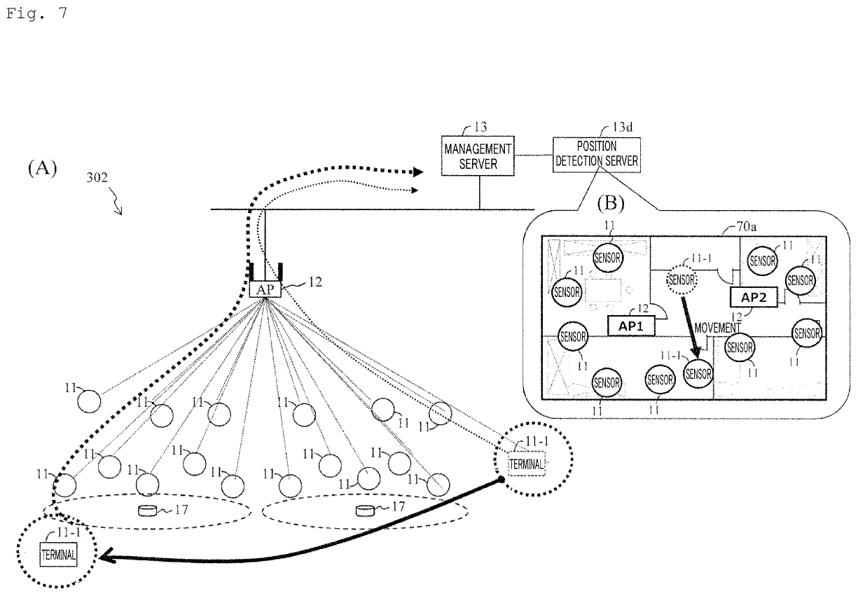

FIG. 7 is a diagram for explaining a display example of the display application 13d4. The display application 13d4 moves the terminal 11-1 whose position has fluctuated to the coordinates after the fluctuation on a floor map 70a displaying the terminal 11.

FIG. 7 (A) is the data collection system 302. It is assumed that the position of the terminal 11-1 is changed in the data collection system 302. For example, the position computation unit 13d3 can find the MAC address in which the value (for example, spatial coordinates or the like) of the location metadata is different from the previous value from among the information [MAC address, location metadata] collected from the information storage unit 13c. The position computation unit 13d3 can determine that the terminal 11-1 has moved from the MAC address.

As shown in FIG. 7 (B), the display application 13d4 displays the positions of the terminal 11 and the network device 12 arranged in the space on the floor map 70a. The display application 13d4 changes the display on the floor map 70a about the moved terminal 11-1 which the position computation unit 13d3 has found to the position of the coordinates of the movement destination. The worker can recognize that the terminal 11-1 has moved by confirming the floor map 70a.

The other display example will be described.

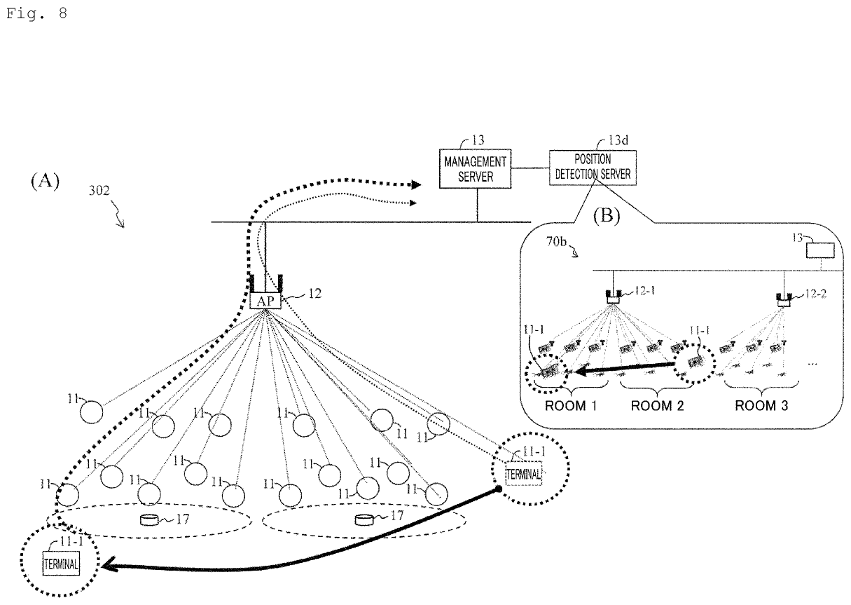

FIG. 8 is a diagram for explaining a display example of the display application 13d4. The display application 13d4 moves the terminal 11-1 whose position has fluctuated to the coordinates after the fluctuation on the network map 70b displaying the terminals 11.

FIG. 8 (A) is the data collection system 302. It is assumed that the position of the terminal 11-1 is changed in the data collection system 302. For example, the position computation unit 13d3 can find the MAC address in which the value (for example, spatial coordinates or the like) of the location metadata is different from the previous value from among the information [MAC address, location metadata] collected from the information storage unit 13c. The position computation unit 13d3 can determine that the terminal 11-1 has moved from the MAC address.

As shown in FIG. 8 (B), the display application 13d4 displays the connection relation between the terminal 11 and the network device 12 on the network map 70b. The network map 70b also displays information on the location (for example, a room number, or the like). The display application 13d4 changes the display on the network map 70b about the moved terminal 11-1 which the position computation unit 13d3 has found to the position of the coordinates of the movement destination. For example, in the display application 13d4, although the terminal 11-1 does not change connection to the network device 12 as shown in FIG. 8 (B), the movement from the room 2 to the room 1 is displayed. The worker can recognize that the terminal 11-1 has moved by confirming the network map 70b.

### Embodiment 3

In the data collection system 302 of the present embodiment, necessary information that the information acquisition unit 13d1 accesses the information storage unit 13c of the management node 13 and obtains is the terminal 11 and the main data (sensing data) linked to it. Specifically, the information acquisition unit 13d1 acquires the information of [MAC address, sensing data] from the information storage unit 13c, and stores it in the database 13d2.

The position computation unit 13d3 arranges the sensing data stored in the database 13d2 in time series for each terminal 11, and defines the terminal 11 in which a large fluctuation occurs in the sensing data arranged in time series as a terminal whose position has fluctuated.

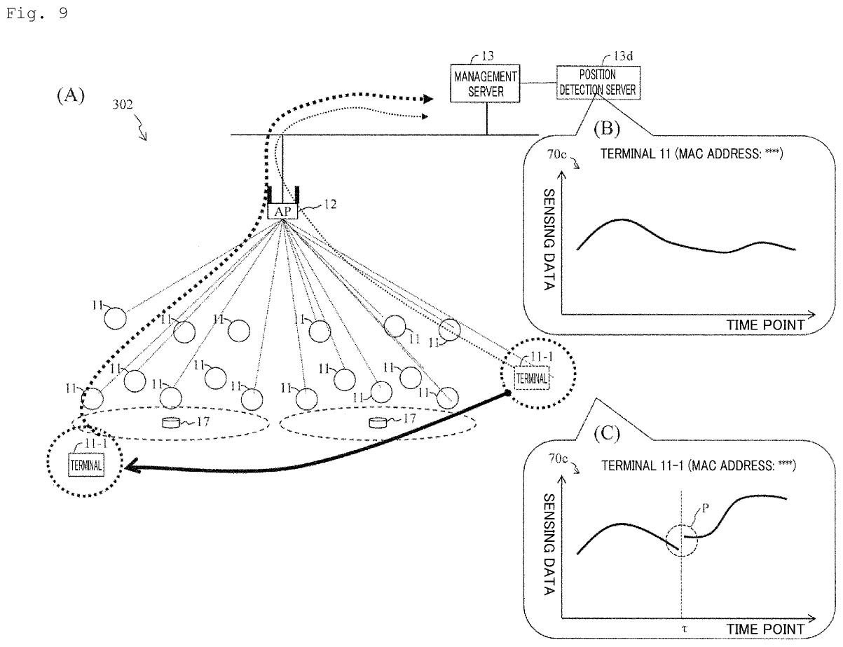

FIG. 9 is a diagram for explaining a display example of the display application 13d4. The display application 13d4 displays the sensing data on a graph 70c in which the sensing data of the terminal 11-1 whose position has fluctuated is arranged in time series, while distinguishing the sensing data before and after the time point when the position fluctuation occurs.

FIG. 9 (A) is the data collection system 302. Each of the terminals 11 is distributed and arranged in various indoor and outdoor locations, and periodically transmits main sensing data (hereinafter referred to as main data) such as air temperature to the management server. It is assumed that the position of the terminal 11-1 is changed in the data collection system 302. For example, the position computation unit 13d3 arranges the information [MAC address, sensing data] collected from the information storage unit 13c in time series for each terminal 11 (refer to FIG. 9 (B) and FIG. 9 (C) ). At this time, it is assumed that a significant fluctuation of the sensing data is observed only at a specific terminal 11-1 at a certain time point τ. As one example, there is a case in which the air temperature around 25° C. is stably sensed so far, and there is a sudden change from a moment and changes to around 30° C. In addition, it is assumed that the change is not gentle, and that the fluctuation is complicated in a short time or a discrete value change lacking continuity is observed. It has been difficult to determine whether this is due to physical factors associated with movement such as application of vibration or air flow different from usual to a sensor portion of the terminal, a connector, a housing, or the like, or to actual some abnormality at an installation site by the existing technique. In the data collection system 302, the terminal 11 acquires environmental information (received radio wave information of wireless communication, received BLE beacon information, acceleration sensor information, sound wave information, visible light information, or the like) other than the main data as the metadata in parallel with the main data, and periodically transmits the metadata to the AP12 and the management server 13. Therefore, the position detection server 13d collates the main data of the terminal 11 with the time series information of the metadata, so that peculiar fluctuation of the main data 70c at the time point t is not caused by a mere temperature change of the site and can be specified to be caused by any physical change added to the terminal 11. In addition, when the metadata capable of specifying the current position is acquired, the position detection server 13d can grasp from where to where the terminal 11 has moved. An example of a metadata collection method capable of specifying the current position is described in an appendix.

As shown in FIG. 9 (B) and FIG. 9 (C), the display application 13d4 displays the sensing data of the terminal 11 in a graph 70c by arranging them in time series. The display application 13d4 may display the plot while changing the color and line type before and after the time point t when the peculiar point P occurs. The worker can recognize that the terminal 11-1 has moved by confirming the graph 70c.

The data collection system 302 can collect the metadata without increasing a load on a low resource terminal. Therefore, the data collection system 302 can perform the following determination by collating the main data with the time series information of the metadata.

(Case 1) The information of “the presence of a peculiar point in the main data” and the information of “the estimation that the installation location is changed by the metadata” at a certain time point are combined to more reliably estimate the movement of the terminal position.

(Case 2) The information of “a large change is not seen in the main data” and the information of “an estimation that the installation place is changed by the metadata” at a certain time point are combined to estimate that the terminal position has moved. When there is no metadata, since the main data is normally received, the manager cannot notice that the terminal has moved, but since the data collection system 302 collates the main data with the time series information of the metadata, it is possible to avoid a situation in which the main data of the location different from the assumed location is collected at some time.

As described above, the data collection system according to the present invention can make the manager notice that the location of the terminal is changed without the manager being aware of it, and can prevent acquisition of wrong sensing data and grasping the situation. In addition, the data collection system according to the present invention collects the location metadata by using a low-layer communication protocol extended region, there is a merit that a position change can be grasped independently of low load, delay (real time reflection), and IP communication.

### Appendix

As described with reference to FIG. 1 and FIG. 4, the terminal 11 stores the location metadata in the extended area 41d of the frame 41 and transmits the location metadata to the management server 13. Here, how the terminal 11 acquires the location metadata will be described.

### (1) BLE Beacon

As shown in FIG. 7 to FIG. 9, a plurality of BLE beacons 17 is arranged in the space. Each terminal 11 receives the beacon signal from each BLE beacon 17, copies the beacon signal information to the extended region of the low layer communication protocol as it is, and performs broadcast transmission. The access point 12 reads the extended region of the low layer communication protocol broadcast-transmitted from the terminal 11 and transfers the data to the management server 13 (eventually, the position detection server 13d). Since the position detection server 13d obtains information on reception intensity of each BLE beacon signal received by each terminal 11 at a certain time point, the position detection server 13d can estimate a distance between each BLE beacon 17 and each terminal 11. When there are three or more BLE beacon signals received by the terminal 11, the position on a plane can be estimated by three-point positioning. When there are four or more BLE beacon signals received by the terminal 11, the position estimation in the space is possible. The management server 13 records the position information of each terminal 11 at each time point computed by the position detection server 13d as the location metadata.

A distance d between the terminal 11 and the BLE beacon 17 is calculated from the reception intensity Y of the terminal 11 and the transmission intensity X of the BLE beacon 17. The reception intensity Y is, for example, an RSSI value (Received Signal Strength Indicator), and when the sensor receives a signal, the sensor side generates the intensity as a numerical value.

The calculation formula of the distance d is as follows.

$$d = 1 {0}^{( ( X - Y ) / N \times 10 )}$$

Here, N is a coefficient which is changed depending on the environment of the space where the beacon is placed.

In the case of an ideal space having no obstacle, N=2.0 is satisfied, if there is a space in which the radio wave propagates while being reflected, N<2.0 is satisfied, and in the case of a space in which the radio wave is absorbed by an obstacle and propagates while being attenuated, N>2.0 is satisfied.

### Specific Measurement Method

Sweep emission of the beacon signal to the BLE beacon 17 is performed, so that the transmission intensity becomes a strong situation from a weak situation, and the RSSI is mutually collected between the communication terminal and a near communication terminal. By performing such sweep emission, reference information is increased, and the distance d and the coefficient N can be easily estimated.

In order to measure the distance between the beacon and the sensor by the beacon signal, it is preferable that a signal intensity reference value is further present. The distance measurement can be performed only by the RSSI, but the measurement result becomes precise depending on whether the RSSI is larger or smaller than the reference value. By comparing these two values, it is possible to determine that the distance is within 1 meter if the RSSI is larger than the reference value, and the distance is farther than that if the RSSI is not larger than the reference value.

The signal intensity reference value is an RSSI value when received at a location with 1 meter away from the transmission device. A beacon is attached to the end of the beacon information and transmitted. The values present only in the case of iBeacon (registered trademark) and AltBeacon format.

### (2) GPS (Global Positioning System)

Each terminal is equipped with a GPS and generates location metadata from the measurement result.

### (3) Radio Wave, Light, and Sound Wave

Without using the BLE beacon, the terminals 11 transmit radio waves, light, and sound waves to each other, and grasp relative positions of them. The intensity of the radio wave, light, and sound wave transmitted by the terminal 11 and the intensity of the radio wave, light, and sound wave received by the other terminal 11 are acquired, the relative position of the terminal is grasped by using the means described in “(1) BLE Beacon”.

### (4) Vibration and Acceleration

The terminal 11 has an accelerometer, and estimates the current position from the accumulation of vibration and acceleration.

### REFERENCE SIGNS LIST

11 Terminal
11a Sensor device
11b Sensing data storage unit
11c Equipment information storage unit
11d1, 11d2 Protocol operation unit
11e, 11e1, 11e2, 11e3 Metadata detection unit
11f Metadata storage processing unit
11g Instruction interpretation unit
12 Network device
12-1, 12-2 Access point
13 Management node
13a Communication protocol operation unit
13b Information processing unit
13c Information storage unit
13d Position detection server
13d1 Information collection unit
13d2 Database
13d3 Position computation unit
13d4 Display application
15 Data collection network
16 Metadata source
41 Frame
41a Logical identifier
41b Transmission source/destination identifier
41c Main data region
41d Extended region
301 to 302 Data collection system

1. A position detection server provided in a data collection system in which a terminal transmits information to a management node at arbitrary timing and the management node stores the information for each of the terminals, wherein
the position detection server comprises a position computation unit configured to compare information from the past and latest information stored in the management node for each of the terminals, and define the terminal having a difference between the information from the past and the latest information as a terminal whose position has fluctuated.

2. The position detection server according to claim 1,
wherein
the information comprises coordinates of the terminal, and
the position computation unit is configured to move, on a floor map displaying the terminals, the terminal whose position has fluctuated to the coordinates of the terminal after the fluctuation.

3. The position detection server according to claim 1,
wherein
the information comprises coordinates of the terminal, and
the position computation unit is configured to move, on a network map displaying the terminals, the terminal whose position has fluctuated to the coordinates of the terminal after the fluctuation.

4. The position detection server according to claim 1,
wherein
the information comprises sensing data acquired by the terminal, and
the position computation unit is configured to display the sensing data on a graph in which the sensing data of the terminal whose position has fluctuated is arranged in time series, and is configured to distinguish the sensing data before and after a time point when the position fluctuation occurs.

5. A position fluctuation grasping method for grasping position fluctuations of a plurality of terminals, the position fluctuation grasping method comprising:
comparing information from the past with latest information for each of the terminals; and
defining the terminal having a difference between the information from the past and the latest information as a terminal whose position has fluctuated.

6. The position fluctuation grasping method according to claim 5, wherein
the information comprises coordinates of the terminal,
the method further comprising moving, on a floor map displaying the terminals, the terminal whose position has fluctuated to the coordinates of the terminal after the fluctuation.

7. The position fluctuation grasping method according to claim 5, wherein
the information comprises coordinates of the terminal,
the method further comprising moving, on a network map displaying the terminals, the terminal whose position has fluctuated to the coordinates of the terminal after the fluctuation.

8. The position fluctuation grasping method according to claim 5, wherein
the information comprises sensing data acquired by the terminal,
the method further comprising
displaying the sensing data on a graph wherein the sensing data of the terminal whose position has fluctuated is arranged in a time series, and
distinguishing the sensing data before and after a time point when the position fluctuation occurs.
